(19) United States
(12) Patent Application Publication
(10) Pub. No.: US 2026/0161243 A1
(43) Pub. Date: Jun. 11, 2026

(54) INTEGRATED INPUT MODULE

(71) Applicant: LITE-ON Technology Corporation, Taipei (TW)

(72) Inventor: Min-Yi WANG, Taipei (TW)

(21) Appl. No.: 19/178,880

(22) Filed: Apr. 15, 2025

Related U.S. Application Data
(60) Provisional application No. 63/657,096, filed on Jun. 6, 2024.

(30) Foreign Application Priority Data
Jan. 14, 2025 (CN) 2025100534793

(51) Int. Cl. G06F 3/041; G06F 3/01; G06F 3/046

(52) U.S. Cl. CPC G06F 3/0412; G06F 3/016; G06F 3/046

(57) ABSTRACT

Disclosed is an integrated input module including a display layer, a touch layer, a writing layer and a tactile feedback layer. The display layer includes a light-emitting side and a backlight side corresponding to each other. The touch layer is disposed on the light-emitting side, and generates a touch signal based on a touch operation. The writing layer generates a writing signal based on a writing operation. The tactile feedback layer generates corresponding vibration feedback based on the touch signal or writing signal. The writing layer is disposed between the light-emitting side of the display layer and the touch layer, and the tactile feedback layer is disposed on the backlight side of the display layer; or the writing layer is disposed between the backlight side of the display layer and the tactile feedback layer. Therefore, a user can perform multiple functional operations in a single action area.

### CROSS REFERENCE TO RELATED PRESENT DISCLOSURE

This application claims the priority benefit of U.S. Provisional Patent Application Ser. No. 63/657,096, filed on Jun. 6, 2024, and China Patent Application No. 2025100534793, filed on Jan. 14, 2025, the entire contents of which are hereby incorporated by reference herein.

### TECHNICAL FIELD

The present disclosure relates to a user command input module, in particular to an integrated input module that allows a user to perform multiple functional operations in a single action area.

### RELATED ART

With the rapid development of science and technology, people have higher requirements for the quality of life. Various information terminals or electronic devices such as desktop computers and laptop computers develop toward diversified functions, thereby driving the development of various input devices, such as touch pads and handwriting tablets. However, various input devices included in electronic devices are required to provide an action area for users to operate. Therefore, in order to comply with the development trend of miniaturization and multi-function of electronic devices, how to provide more diverse input methods in a limited operation space is a problem that those skilled in the art need to solve.

### SUMMARY

Embodiments of the present disclosure provide an integrated input module that can provide more diverse input methods in a limited operation space to provide users with a good operating experience.

In order to solve the above technical problems, the present disclosure is implemented as follows.

The present disclosure provides an integrated input module, which includes a display layer, a touch layer, a writing layer and a tactile feedback layer. The display layer includes a light-emitting side and a backlight side corresponding to each other. The touch layer is disposed on the light-emitting side of the display layer, and the touch layer is configured to generate a touch signal based on a user's touch operation on the touch layer. The writing layer is configured to generate a writing signal based on a user's writing operation on the writing layer. The tactile feedback layer is configured to generate vibration feedback based on the touch signal or the writing signal. The writing layer is disposed between the light-emitting side of the display layer and the touch layer, and the tactile feedback layer is disposed on the backlight side of the display layer; or the writing layer is disposed between the backlight side of the display layer and the tactile feedback layer.

In the integrated input module of the embodiment of the present disclosure, by the design of stacking the display layer, the touch layer, the writing layer and the tactile feedback layer, the tactile feedback function, the writing function, the display function and the touch function are integrated, so that the user can perform multiple functional operations in the single action area to comply with the development trend of miniaturization and multi-functions, provide more diverse input methods in limited operation space, and provide users with a good operating experience. In addition, by stacking the touch layer, writing layer, display layer and tactile feedback layer in sequence from top to bottom or stacking the touch layer, display layer, writing layer and tactile feedback layer in sequence from top to bottom, the integrated input module can support the operation of active pen or passive pen, and the execution of each layer cannot affect each other.

### BRIEF DESCRIPTION OF THE DRAWINGS

The accompanying drawings described herein are used to provide further understanding for the present disclosure, and constitute a part of the present disclosure. The exemplary embodiments of the present disclosure and their descriptions are used to explain the present disclosure, and do not constitute an improper limitation of the present disclosure. In the accompanying drawings:

FIG. 1 is a schematic view of the appearance of a computer host using an integrated input module of the present disclosure;

FIG. 2 is a schematic view of the appearance of a laptop computer using an integrated input module of the present disclosure;

FIG. 3 is a schematic cross-sectional view of an integrated input module according to a first embodiment of the present disclosure;

FIG. 4 is a top view of a tactile feedback circuit board of FIG. 3;

FIG. 5 is a top view of a tactile feedback circuit board according to an embodiment of the present disclosure;

FIG. 6 is a schematic cross-sectional view of an integrated input module according to a second embodiment of the present disclosure;

FIG. 7 is a top view of a tactile feedback circuit board of FIG. 6;

FIG. 8 is a schematic cross-sectional view of an integrated input module according to a third embodiment of the present disclosure; and

FIG. 9 is a schematic cross-sectional view of an integrated input module according to a fourth embodiment of the present disclosure.

### DETAILED DESCRIPTION OF THE EMBODIMENTS

The embodiments of the present disclosure will be described below with reference to the drawings. Directional terminology mentioned in the following embodiments, such as up, down, left, right, front, back, etc., is used with reference to the orientation of the Figure(s) being described. As such, the directional terminology is used for purposes of illustration and not for limitation of the present disclosure. In the figures, the same reference numerals represent the same or similar elements or process flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination thereof can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween. In addition, “thickness” in this specification is used to indicate the length in the up-down direction (i.e., the direction Z) in the figures.

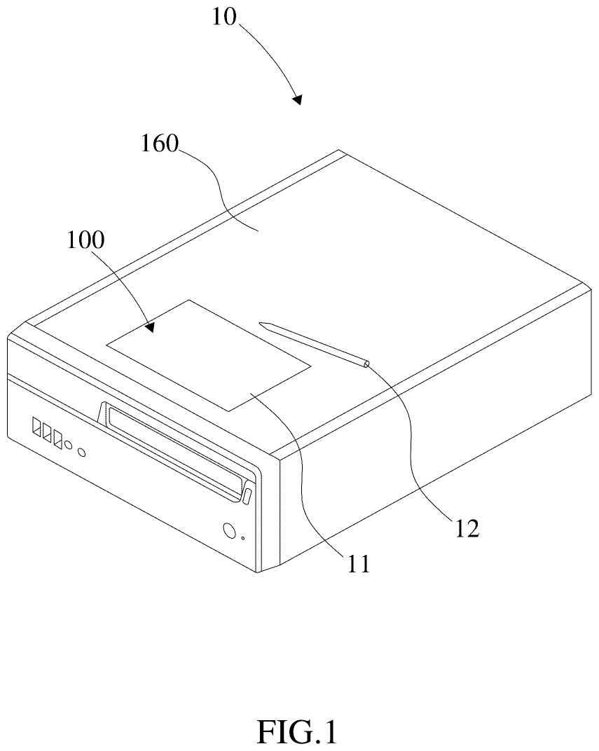

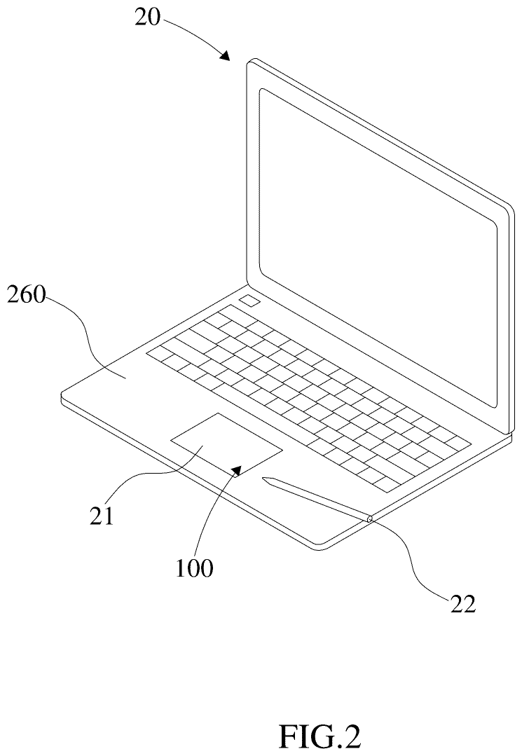

FIG. 1 is a schematic view of the appearance of a computer host using an integrated input module of the present disclosure. FIG. 2 is a schematic view of the appearance of a laptop computer using an integrated input module of the present disclosure. As shown in FIG. 1 to FIG. 2, an integrated input module 100 may be applied to electronic devices, such as the computer host 10 of FIG. 1 and the laptop computer 20 of FIG. 2, but is not limited thereto. The integrated input module 100 and the electronic device may be electrically connected to each other through a bus or wires, and the integrated input module 100 and a processor (not shown) of the electronic device may communicate with each other through the bus or wires.

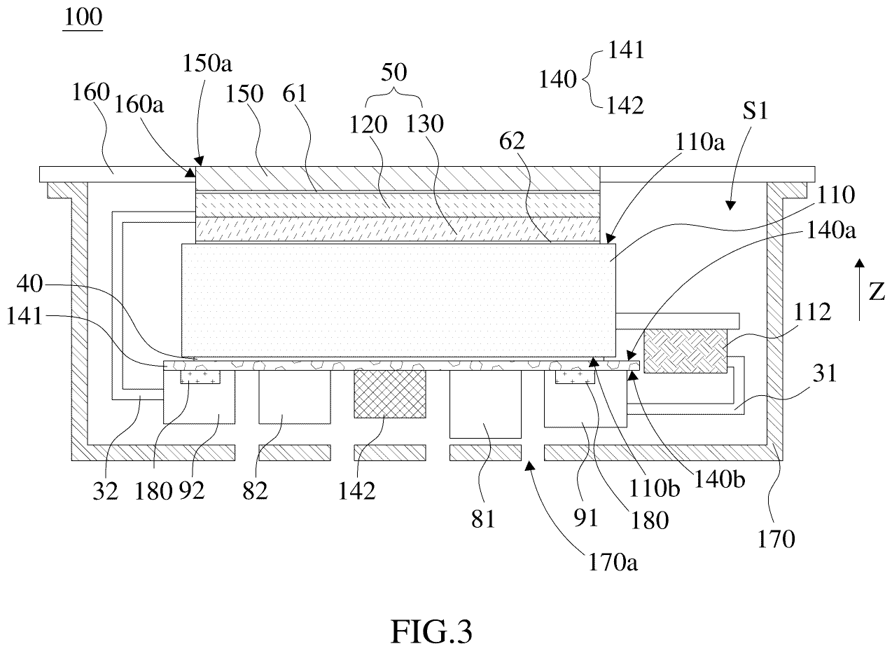

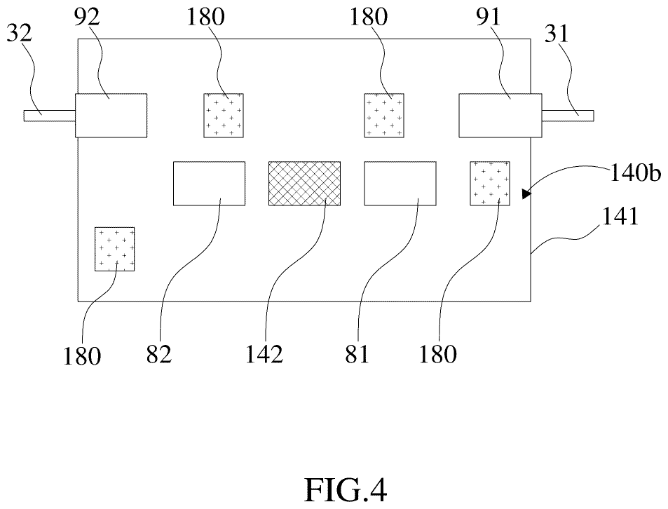

FIG. 3 is a schematic cross-sectional view of an integrated input module according to a first embodiment of the present disclosure, and FIG. 4 is a top view of a tactile feedback circuit board of FIG. 3. As shown in FIG. 3 and FIG. 4, the integrated input module 100 comprises a display layer 110, a touch layer 120, a writing layer 130 and a tactile feedback layer 140. The display layer 110 comprises a light-emitting side 110 a (i.e., the display side) and a backlight side 110b corresponding to each other. The touch layer 120 is disposed on the light-emitting side 110 of the display layer 110, and the touch layer 120 is configured to generate a touch signal according to a user's touch operation on the touch layer 120. The writing layer 130 is disposed between the light-emitting side 110a of the display layer 110 and the touch layer 120, and the writing layer 130 is configured to generate a writing signal according to a user's writing operation on the writing layer 130. The tactile feedback layer 140 is disposed on the backlight side 110b of the display layer 110, and the tactile feedback layer 140 is configured to generate corresponding vibration feedback according to the touch signal or the writing signal. By the design of stacking the display layer 110, the touch layer 120, the writing layer 130 and the tactile feedback layer 140, the tactile feedback function, the writing function, the display function and the touch function are integrated, so that the user can perform multiple functional operations in the action area 11 (as shown in FIG. 1).

In one embodiment, the touch layer 120 and the writing layer 130 are transparent structures, so that the touch layer 120 and the writing layer 130 do not affect the image display of the display layer 110; the touch layer 120 and the writing layer 130 may be made of transparent conductive materials. The writing layer 130 may detect the movement trajectory of the user's writing operation using the active pen 12 (as shown in FIG. 1) to generate a writing signal corresponding thereto. Therefore, the writing signal may comply with at least one of the Microsoft Pen Protocol (MPP), the Universal Stylus Initiative (USI) protocol, and the Huawei Pen Protocol (HPP). The display layer 110 may comprise at least one of a liquid crystal display (LCD), an organic light emitting diode (OLED) display, and an electronic paper display (e-paper display, EPD). The thickness of the display layer 110 may be greater than or equal to 1.22 millimeter (mm), but is not limited thereto. In order to prevent the thickness of the integrated input module 100 from being too large and to prevent the vibration feedback of the tactile feedback layer 140 from being insignificant, the thickness of the display layer 110 needs to be less than or equal to 1.5 mm. In other words, the thickness of the display layer 110 may be greater than or equal to 1.22 mm and less than or equal to 1.5 mm.

In one embodiment, when the writing layer 130 is disposed between the display layer 110 and the touch layer 120, the touch layer 120 and the writing layer 130 may be integrated into one body. Specifically, the touch layer 120 and the writing layer 130 may be integrated into an integrated input layer 50.

In another embodiment, the integrated input module 100 further comprises a protective layer 150, a cover body 160, a supporting body 170 and a buffer member 180. The protective layer 150 is disposed on the touch layer 120 to cover the touch layer 120. The supporting body 170 is combined with the cover body 160 to form an accommodation space S1, wherein the supporting body 170 may be provided with at least one opening 170a, the cover body 160 has an opening 160a, and the at least one opening 170a of the supporting body 170 and the opening 160a of the cover body 160 communicate with the accommodation space S1. Specifically, when the integrated input module 100 is applied to an electronic device (e.g., the computer host 10 in FIG. 1), the display layer 110, the touch layer 120, the protective layer 150, the writing layer 130 and the tactile feedback layer 140 are disposed in the accommodation space S1, and the surface 150a of the protective layer 150 (i.e., the surface of the protective layer 150 away from the touch layer 120) is exposed from the opening 160a of the cover body 160. The buffer member 180 is disposed on the tactile feedback layer 140, and may or may not be in contact with the supporting body 170, so as to absorb the vibration feedback of the tactile feedback layer 140 by the buffer member 180.

In one embodiment, the supporting body 170 may be a metal piece, and the supporting body 170 and the cover body 160 may be combined by screw locking, latch locking, glue bonding or ultrasonic welding. The material of the buffer member 180 may comprise rubber, silicone, foam or a combination thereof. The buffer member 180 may be used as a shock absorber, and effectively prevent the components (e.g., the tactile feedback layer 140) disposed in the accommodation space S1 from colliding with the supporting body 170, thereby achieving the effect of noise reduction. In addition, the size, shape, thickness, quantity and location of the buffer members 180 may be adjusted and designed according to actual needs (e.g., the vibration amplitude of the tactile feedback layer 140 or heat dissipation requirements). Furthermore, the size, shape, quantity and location of the at least one opening 170a of the supporting body 170 may be adjusted and designed according to actual needs (e.g., the heat dissipation requirements of the display layer 110 and the tactile feedback layer 140 or the connection requirements between components located within the accommodation space S1 and components located outside the accommodation space S1). In one embodiment, the protective layer 150 and the cover body 160 may be integrally formed (that is, the protective layer 150 and the cover body 160 may be combined into a single structure), and the materials of the protective layer 150 and the cover body 160 may comprise, but are not limited to, glass, plastic, or a combination thereof, and the thickness of the protective layer 150 may be, but not limited to, 1.1 mm.

In one embodiment, the tactile feedback layer 140 may have a first surface 140a and a second surface 140b corresponding to each other. The tactile feedback layer 140 may comprise a tactile feedback circuit board 141 and at least one vibrator 142. The display layer 110 is attached to the first surface 140a of the tactile feedback layer 140. The at least one vibrator 142 is disposed on the second surface 140b of the tactile feedback layer 140, and the at least one vibrator 142 is configured to generate the corresponding vibration feedback according to the touch signal or the writing signal.

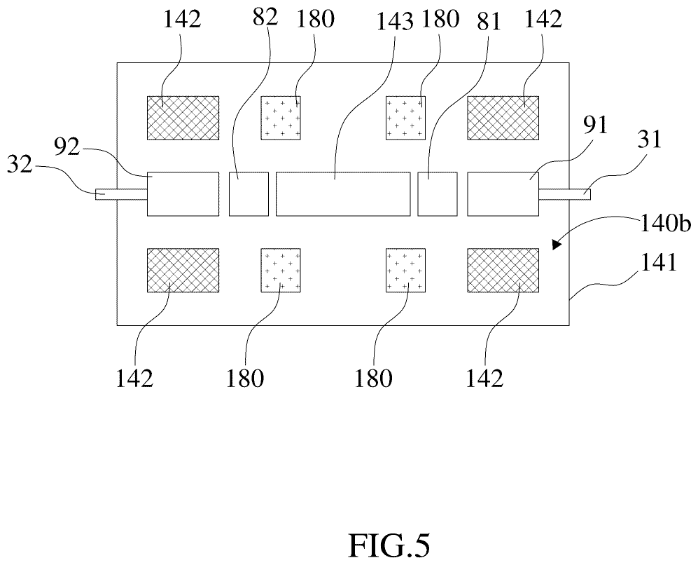

In one embodiment, the number and location of the vibrators 142 may be adjusted according to actual needs. As shown in FIG. 4, when the number of the vibrators 142 is only one, the vibrator 142 may be disposed at the center of the tactile feedback circuit board 141, so that the vibration generated by the vibrator 142 may be transmitted to each position of the action area 11 (as shown in FIG. 1). Alternatively, as shown in FIG. 5, when there are a plurality of vibrators 142, these vibrators 142 may be dispersedly arranged on the second surface 140b of the tactile feedback layer 140 (for example, four vibrators 142 are dispersedly arranged at the four corners of the second surface 140b) to simultaneously generate vibration feedback when the user performs a touch operation or writing operation in the action area 11 (as shown in FIG. 1). At this time, in order to make the vibration amplitude of each position of the action area 11 the same, the tactile feedback layer 140 may further comprise a metal vibration transmission sheet 143 disposed at the center of the second surface 140b of the tactile feedback layer 140. The vibration transmission sheet 143 is configured to transmit the vibrations generated by the vibrators 142, so that the user can experience the same vibration amplitude when performing the touch operation or the writing operation at different positions of the action area 11. The shape of the metal vibration transmission sheet 143 may be, but is not limited to, a rectangle, and the material of the metal vibration transmission sheet 143 may be, but is not limited to, iron.

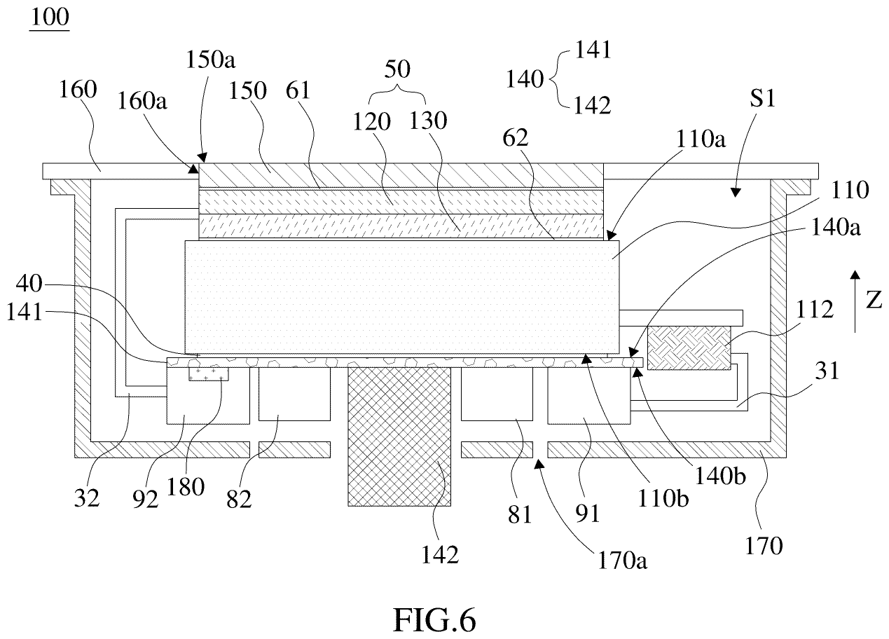

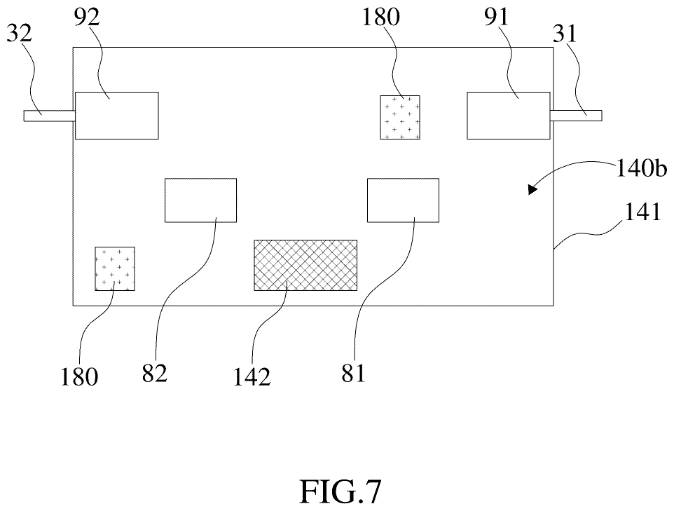

In one embodiment, as shown in FIG. 3, the vibrator 142 may comprise a piezoelectric ceramic actuator, wherein the thickness of the piezoelectric ceramic actuator may be, but is not limited to, 0.5 mm. In another embodiment, FIG. 6 is a schematic cross-sectional view of an integrated input module according to a second embodiment of the present disclosure, and FIG. 7 is a top view of a tactile feedback circuit board of FIG. 6. As shown in FIG. 6 and FIG. 7, the vibrator 142 may comprise a linear resonant actuator, wherein the thickness of the linear resonant actuator may be, but is not limited to, 2.11 mm. Since the thickness of the linear resonant actuator is relatively thick, one end of the linear resonant actuator may be exposed from the opening 170a of the supporting body 170. In other words, the vibrator 142 may comprise at least one of a piezoelectric ceramic actuator and a linear resonant actuator.

In one embodiment, the material of the tactile feedback circuit board 141 may be, but is not limited to, FR-4, a ceramic substrate, or a Teflon sheet. The first surface 140a of the tactile feedback layer 140 may be attached to the display layer 110 through an adhesive layer 40, wherein the adhesive layer 40 may be a primer, and the thickness of the adhesive layer 40 may be, but is not limited to, 0.05 mm.

In one embodiment, the integrated input module 100 may further comprise a first glue layer 61 and a second glue layer 62. The first glue layer 61 is disposed between the protective layer 150 and the integrated input layer 50, and the first glue layer 61 is connected to the protective layer 150 and the integrated input layer 50. The second glue layer 62 is disposed between the integrated input layer 50 and the display layer 110, and the second glue layer 62 is connected to the integrated input layer 50 and the display layer 110. The first glue layer 61 and the second glue layer 62 are transparent glue layers, so that the first glue layer 61 and the second glue layer 62 do not affect the image display of the display layer 110. The materials of the first glue layer 61 and the second glue layer 62 may comprise at least one of acrylic resin, silicone resin, polyurethane-based resin, and epoxy resin. The thickness of the first glue layer 61 may be, but is not limited to, 0.075 mm. The thickness of the second glue layer 62 may be, but is not limited to, 0.15 mm.

In one embodiment, as shown in FIG. 3, the integrated input module 100 may further comprise a first electronic component 81 and a second electronic component 82. The first electronic component 81 is disposed on the second surface 140b of the tactile feedback layer 140 and is electrically connected to the display layer 110 to control the display layer 110. The second electronic component 82 is disposed on the second surface 140b of the tactile feedback layer 140 and is electrically connected to the integrated input layer 50 to control the integrated input layer 50. The first electronic component 81 and the second electronic component 82 may be, but are not limited to, integrated circuits (ICs). The thickness of the first electronic component 81 may be, but is not limited to, 1.2 mm, and the thickness of the second electronic component 82 may be, but is not limited to, 0.8 mm.

In addition, the integrated input module 100 may further comprise a first connector 91, a second connector 92, a first signal transmission element 31 and a second signal transmission element 32. The display layer 110 may comprise a display connector 112. The first signal transmission element 31 may be, but is not limited to, a flexible flat cable (FFC). The second signal transmission element 32 may be, but is not limited to, a flexible printed circuit (FPC). The first connector 91 and the second connector 92 are disposed on the second surface 140b of the tactile feedback layer 140 and are electrically connected to the tactile feedback circuit board 141 to electrically connect the first electronic component 81 and the second electronic component 82 through the tactile feedback circuit board 141. The first connector 91 and the display connector 112 may be, but are not limited to, FFC connectors, and the second connector 92 may be, but are not limited to, a FPC connector. The first electronic component 81 is electrically connected to the display layer 110 through the first connector 91, the first signal transmission element 31 and the display connector 112, and the second electronic component 82 is electrically connected to the integrated input layer 50 through the second connector 92 and the second signal transmission element 32. The thicknesses of the first connector 91, the second connector 92 and the display connector 112 may be, but are not limited to, 1.1 mm.

In one embodiment, the thickness of the integrated input module 100 is greater than or equal to 3.5 mm and less than or equal to 4 mm to achieve miniaturization of the integrated input module 100.

In the integrated input module 100 of FIG. 3, the thickness relationships of the components are as follows. The thickness of the display layer 110 may be greater than the thickness of the first electronic component 81. The thickness of the first electronic component 81 may be greater than the thickness of the protective layer 150. The thickness of the protective layer 150 may be equal to the thickness of the first connector 91 and the thickness of the second connector 92. The thickness of the protective layer 150 may be greater than the thickness of the second electronic component 82. The thickness of the second electronic component 82 may be greater than the thickness of the supporting body 170. The thickness of the supporting body 170 may be greater than the thickness of the buffer member 180. The thickness of the buffer member 180 may be greater than the thickness of the tactile feedback layer 140. The thickness of the tactile feedback layer 140 may be greater than the thickness of the second glue layer 62. The thickness of the second glue layer 62 may be greater than the thickness of the first glue layer 61. The thickness of the first glue layer 61 may be greater than the thickness of the integrated input layer 50. The thickness of the integrated input layer 50 may be greater than the thickness of the adhesive layer 40. The thickness of the supporting body 170 may be, but is not limited to, 0.7 mm. It should be noted that the thickness of each component in FIG. 3 is not drawn according to actual proportional relationships.

In the integrated input module 100 of FIG. 6, the thickness relationships of the components are as follows. The thickness of the linear resonant actuator as the vibrator 142 may be greater than the thickness of the display layer 110. The thickness of the display layer 110 may be greater than the thickness of the first electronic component 81. The thickness of the first electronic component 81 may be greater than the thickness of the protective layer 150. The thickness of the protective layer 150 may be equal to the thickness of the first connector 91 and the thickness of the second connector 92. The thickness of the protective layer 150 may be greater than the thickness of the second electronic component 82. The thickness of the second electronic component 82 may be greater than the thickness of the supporting body 170. The thickness of the supporting body 170 may be greater than the thickness of the tactile feedback circuit board 141. The thickness of the tactile feedback circuit board 141 may be greater than the thickness of the second glue layer 62. The thickness of the second glue layer 62 may be greater than the thickness of the first glue layer 61. The thickness of the first glue layer 61 may be greater than the thickness of the integrated input layer 50. The thickness of the integrated input layer 50 may be greater than the thickness of the adhesive layer 40. The thickness of the supporting body 170 may be, but is not limited to, 0.5 mm. It should be noted that the thickness of each component in FIG. 6 is not drawn according to actual proportional relationships.

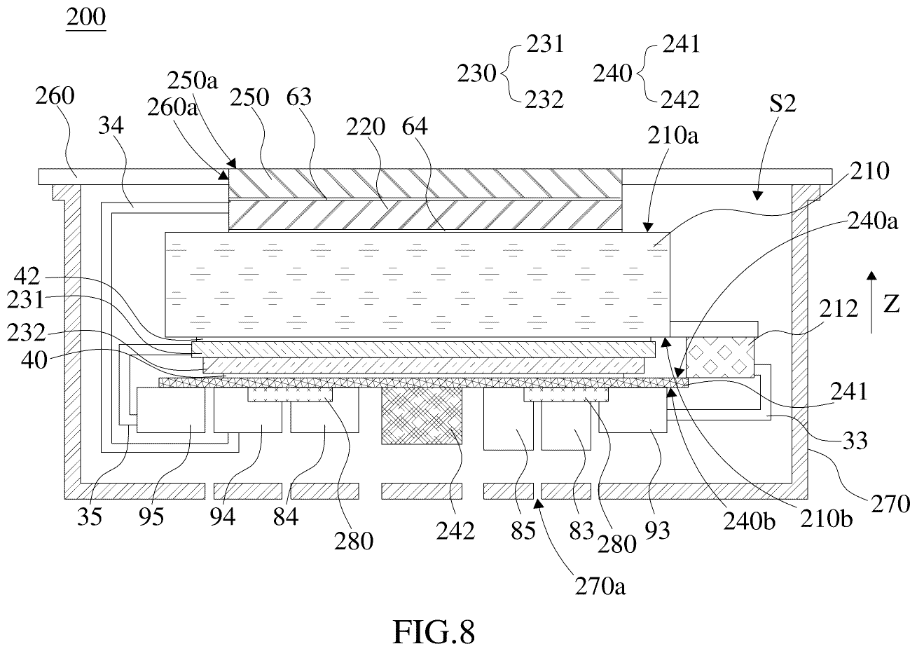

FIG. 8 is a schematic cross-sectional view of an integrated input module according to a third embodiment of the present disclosure. As shown in FIG. 8, an integrated input module 200 comprises a display layer 210, a touch layer 220, a writing layer 230 and a tactile feedback layer 240. The display layer 210 comprises a light-emitting side 210a (i.e., the display side) and a backlight side 210b corresponding to each other. The touch layer 220 is disposed on the light-emitting side 210a of the display layer 210, and the touch layer 220 is configured to generate a touch signal according to a user's touch operation on the touch layer 220. The writing layer 230 is disposed between the backlight side 210b of the display layer 210 and the tactile feedback layer 240, and the writing layer 230 is configured to generate a writing signal according to a user's writing operation on the writing layer 230. The tactile feedback layer 240 is configured to generate corresponding vibration feedback according to the touch signal or the writing signal. By the design of stacking the display layer 210, the touch layer 220, the writing layer 230 and the tactile feedback layer 240, the tactile feedback function, the writing function, the display function and the touch function are integrated, so that the user can perform multiple functional operations in the action area 21 (as shown in FIG. 2).

In one embodiment, the touch layer 220 is a transparent structure, so that the touch layer 220 does not affect the image display of the display layer 210. The touch layer 220 may be made of a transparent conductive material. The writing layer 230 may detect the movement trajectory of the user's writing operation using the passive pen 22 (as shown in FIG. 2, i.e., an electromagnetic pen or an iron pen) to generate the writing signal corresponding thereto. The display layer 210 may comprise at least one of a liquid crystal display (LCD), an organic light emitting diode (OLED) display, and an electronic paper display (e-paper display, EPD). The thickness of the display layer 210 may be greater than or equal to 1.22 mm, but is not limited thereto. In order to prevent the thickness of the integrated input module 200 from being too large, to prevent the vibration feedback of the tactile feedback layer 240 from being insignificant, and to prevent the touch layer 220 and the writing layer 230 from interfering with each other during their respective operations, the thickness of the display layer 210 needs to be less than or equal to 1.5 mm. In other words, the thickness of the display layer 210 may be greater than or equal to 1.22 mm and less than or equal to 1.5 mm.

In one embodiment, the writing layer 230 may comprise an electromagnetic resonance (EMR) circuit board 231 and a magnetic conductive plate 232. The electromagnetic resonance circuit board 231 may be attached to the backlight side 210b of the display layer 210, and the magnetic conductive plate 232 may be disposed between the electromagnetic resonance circuit board 231 and the tactile feedback layer 240 to uniformly distribute magnetism of the writing layer 230. The thickness of the electromagnetic resonance circuit board 231 may be, but is not limited to, 0.2 mm. The material of the electromagnetic resonance circuit board 231 may comprise, but is not limited to, polyimide (PI). The thickness of the magnetic conductive plate 232 may be, but is not limited to, 0.3 mm. The material of the magnetic conductive plate 232 may be, but is not limited to, silicon alloy steel, such as silicon steel sheets. In addition, the electromagnetic resonance circuit board 231 may be attached to the backlight side 210b of the display layer 210 through an adhesive layer 42, and the thickness of the adhesive layer 42 may be, but is not limited to, 0.05 mm.

In one embodiment, the integrated input module 200 further comprise a protective layer 250, a cover body 260, a supporting body 270 and a buffer member 280. The protective layer 250 is disposed on the touch layer 220 to cover the touch layer 220. The supporting body 270 is combined with the cover body 260 to form an accommodation space S2, wherein the supporting body 270 may be provided with at least one opening 270a, the cover body 260 has an opening 260a, and the at least one opening 270a of the supporting body 270 and the opening 260a of the cover body 260 communicate with the accommodation space S2. Specifically, when the integrated input module 200 is applied to an electronic device (e.g., the laptop computer 20 in FIG. 2), the display layer 210, the touch layer 220, the protective layer 250, the writing layer 230 and the tactile feedback layer 240 are disposed in the accommodation space S2, and the surface 250a of the protective layer 250 is exposed from the opening 260a of the cover body 260. The buffer member 280 is disposed on the tactile feedback layer 240 and may or may not contact the supporting body 270, so as to absorb the vibration feedback of the tactile feedback layer 240 by the buffer member 280.

In one embodiment, the supporting body 270 may be a metal piece, and the supporting body 270 and the cover body 260 may be combined by screw locking, latch locking, glue bonding or ultrasonic welding. The material of the buffer member 280 may comprise rubber, silicone, foam or a combination thereof. The buffer member 280 may be used as a shock absorber, and effectively prevent the components (e.g., the tactile feedback layer 240) disposed in the accommodation space S2 from colliding with the supporting body 270, thereby achieving the effect of noise reduction. In addition, the size, shape, thickness, quantity and location of the buffer members 280 may be adjusted and designed according to actual needs (e.g., the vibration amplitude of the tactile feedback layer 240 or heat dissipation requirements). Furthermore, the size, shape, quantity and location of the at least one opening 270a of the supporting body 270 may be adjusted and designed according to actual needs (e.g., the heat dissipation requirements of the display layer 210 and the tactile feedback layer 240 or the connection requirements between components located within the accommodation space S2 and components located outside the accommodation space S2). In one embodiment, the protective layer 250 and the cover body 260 may be integrally formed (that is, the protective layer 250 and the cover body 260 are combined into a single structure), and the materials of the protective layer 250 and the cover body 260 may comprise, but are not limited to, glass, plastic, or a combination thereof, and the thickness of the protective layer 250 may be, but not limited to, 1.1 mm.

In one embodiment, the tactile feedback layer 240 may have a first surface 240a and a second surface 240b corresponding to each other. The tactile feedback layer 240 may comprise a tactile feedback circuit board 241 and at least one vibrator 242. The writing layer 230 is attached to the first surface 240a of the tactile feedback layer 240. The at least one vibrator 242 is disposed on the second surface 240b of the tactile feedback layer 240, and the at least one vibrator 242 is configured to generate the corresponding vibration feedback according to the touch signal or the writing signal.

In one embodiment, the number and location of the vibrators 242 may be adjusted according to actual needs. For example, the number and location of the vibrators 242 may be the same as or similar to those of the vibrators 142 of FIG. 4 or FIG. 5, which are not described again.

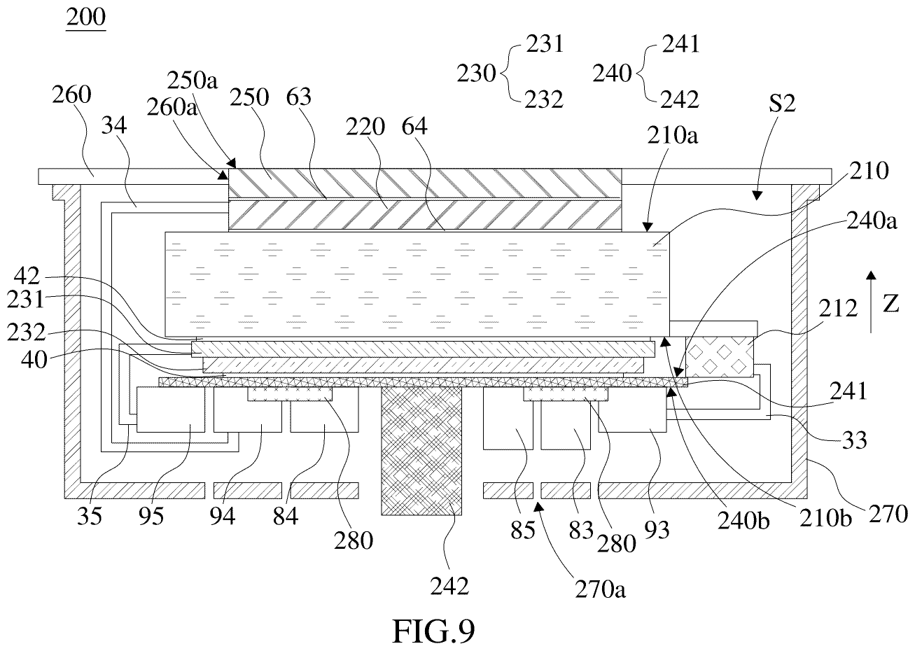

In one embodiment, as shown in FIG. 8, the vibrator 242 may comprise a piezoelectric ceramic actuator, wherein the thickness of the piezoelectric ceramic actuator may be, but is not limited to, 0.5 mm. In another embodiment, FIG. 9 is a schematic cross-sectional view of an integrated input module according to a fourth embodiment of the present disclosure, and this embodiment is substantially the same as the embodiment of FIG. 8, so the similarities are not be described again. As shown in FIG. 9, the vibrator 242 may comprise a linear resonant actuator, where the thickness of the linear resonant actuator may be, but is not limited to, 2.11 mm. Since the thickness of the linear resonant actuator is relatively thick, one end of the linear resonant actuator may be exposed from the opening 270a of the supporting body 270. In other words, the vibrator 242 may comprise at least one of a piezoelectric ceramic actuator and a linear resonant actuator.

In one embodiment, the material of the tactile feedback circuit board 241 may be, but is not limited to, FR-4, a ceramic substrate, or a Teflon sheet. The first surface 240a of the tactile feedback layer 240 may be attached to the writing layer 230 through an adhesive layer 40, where the adhesive layer 40 may be a primer, and the thickness of the adhesive layer 40 may be, but is not limited to, 0.05 mm.

In one embodiment, the integrated input module 200 may further comprise a third glue layer 63 and a fourth glue layer 64. The third glue layer 63 is disposed between the protective layer 250 and the touch layer 220, and the third glue layer 63 is connected to the protective layer 250 and the touch layer 220. The fourth glue layer 64 is disposed between the touch layer 220 and the display layer 210, and the fourth glue layer 64 is connected to the touch layer 220 and the light-emitting side 210a of the display layer 210. The third glue layer 63 and the fourth glue layer 64 are transparent glue layers, so that the third glue layer 63 and the fourth glue layer 64 do not affect the image display of the display layer 210. The materials of the third glue layer 63 and the fourth glue layer 64 may comprise at least one of acrylic resin, silicone resin, polyurethane-based resin, and epoxy resin. The thickness of the third glue layer 63 may be, but is not limited to, 0.075 mm. The thickness of the fourth glue layer 64 may be, but is not limited to, 0.15 mm.

In one embodiment, the integrated input module 200 may further comprise a third electronic component 83, a fourth electronic component 84 and a fifth electronic component 85. The third electronic component 83 is disposed on the second surface 240b of the tactile feedback layer 240 and is electrically connected to the display layer 210 to control the display layer 210. The fourth electronic component 84 is disposed on the second surface 240b of the tactile feedback layer 240 and is electrically connected to the touch layer 220 to control the touch layer 220. The fifth electronic component 85 is disposed on the second surface 240b of the tactile feedback layer 240 and is electrically connected to the writing layer 230 to control the writing layer 230. The third electronic component 83, the fourth electronic component 84 and the fifth electronic component 85 may be, but are not limited to, integrated circuits (ICs). The thickness of the third electronic component 83 may be, but is not limited to, 1.2 mm, the thickness of the fourth electronic component 84 may be, but not limited to, 0.8 mm, and the thickness of the fifth electronic component 85 may be, but is not limited to, 1.2 mm.

In addition, the integrated input module 200 may further comprise a third connector 93, a fourth connector 94, a fifth connector 95, a third signal transmission element 33, a fourth signal transmission element 34, and a fifth signal transmission element 35. The display layer 210 may comprise a display connector 212. The third signal transmission element 33 may be, but is not limited to, a flexible flat cable (FFC). The fourth signal transmission element 34 and the fifth signal transmission element 35 may be, but are not limited to, flexible printed circuits (FPCs). The third connector 93, the fourth connector 94 and the fifth connector 95 are disposed on the second surface 240b of the tactile feedback layer 240 and are electrically connected to the tactile feedback circuit board 241 to electrically connect the third electronic component 83, the fourth electronic component 84 and the fifth electronic component 85 through the tactile feedback circuit board 241. The third connector 93 and the display connector 212 may be, but are not limited to, FFC connectors, and the fourth connector 94 and the fifth connector 95 may be, but are not limited to, FPC connectors. The third electronic component 83 is electrically connected to the display layer 210 through the third connector 93, the third signal transmission element 33 and the display connector 212. The fourth electronic component 84 is electrically connected to the touch layer 220 through the fourth connector 94 and the fourth signal transmission element 34. The fifth electronic component 85 is electrically connected to the writing layer 230 through the fifth connector 95 and the fifth signal transmission element 35. The thicknesses of the third connector 93, the fourth connector 94, the fifth connector 95 and the display connector 212 may be, but are not limited to, 1.1 mm.

In one embodiment, the thickness of the integrated input module 200 is greater than or equal to 3.5 mm and less than or equal to 4 mm to achieve miniaturization of the integrated input module 200.

In the integrated input module 200 of FIG. 8, the thickness relationships of the components are as follows. The thickness of the display layer 210 may be greater than the thickness of the third electronic component 83. The thickness of the third electronic component 83 may be equal to the thickness of the fifth electronic component 85. The thickness of the fifth electronic component 85 may be greater than the thickness of the protective layer 250. The thickness of the protective layer 250 may be equal to the thickness of the third connector 93, the thickness of the fourth connector 94 and the thickness of the fifth connector 95. The thickness of the protective layer 250 may be greater than the thickness of the fourth electronic component 84. The thickness of the fourth electronic component 84 may be greater than the thickness of the supporting body 270. The thickness of the supporting body 270 may be greater than the thickness of the buffer member 280. The thickness of the buffer member 280 may be greater than the thickness of the tactile feedback layer 240. The thickness of the tactile feedback layer 240 may be greater than the thickness of the magnetic conductive plate 232. The thickness of the magnetic conductive plate 232 may be greater than the thickness of the electromagnetic resonance circuit board 231. The thickness of the electromagnetic resonance circuit board 231 may be greater than the thickness of the touch layer 220. The thickness of the touch layer 220 may be greater than the thickness of the fourth glue layer 64. The thickness of the fourth glue layer 64 may be greater than the thickness of the third glue layer 63. The thickness of the third glue layer 63 may be greater than the thicknesses of the adhesive layer 40 and the thicknesses of the adhesive layer 42. The thickness of the supporting body 270 may be, but is not limited to, 0.7 mm. It should be noted that the thickness of each component in FIG. 8 is not drawn according to actual proportional relationships.

In the integrated input module 200 of FIG. 9, the thickness relationships of the components are as follows. The thickness of the linear resonant actuator as the vibrator 242 may be greater than the thickness of the display layer 210. The thickness of the display layer 210 may be greater than the thickness of the third electronic component 83. The thickness of the third electronic component 83 may be equal to the thickness of the fifth electronic component 85. The thickness of the third electronic component 83 may be greater than the thickness of the protective layer 250. The thickness of the protective layer 250 may be equal to the thickness of the third connector 93, the thickness of the fourth connector 94 and the thickness of the fifth connector 95. The thickness of the protective layer 250 may be greater than the thickness of the fourth electronic component 84. The thickness of the fourth electronic component 84 may be greater than the thickness of the supporting body 270. The thickness of the supporting body 270 may be greater than the thickness of the tactile feedback circuit board 241. The thickness of the tactile feedback circuit board 241 may be greater than the thickness of the magnetic conductive plate 232. The thickness of the magnetic conductive plate 232 may be greater than the thickness of the electromagnetic resonance circuit board 231. The thickness of the electromagnetic resonance circuit board 231 may be greater than the thickness of the touch layer 220. The thickness of the touch layer 220 may be greater than the thickness of the fourth glue layer 64. The thickness of the fourth glue layer 64 may be greater than the thickness of the third glue layer 63. The thickness of the third glue layer 63 may be greater than the thickness of the adhesive layer 40 and the thicknesses of the adhesive layer 42. The thickness of the supporting body 270 may be, but is not limited to, 0.5 mm. It should be noted that the thickness of each component in FIG. 9 is not drawn according to actual proportional relationships.

To sum up, by the design of stacking the display layer, touch layer, writing layer and tactile feedback layer, the tactile feedback function, the writing function, the display function and the touch function are integrated, so that the user can perform multiple functional operations in the single action area to comply with the development trend of miniaturization and multi-functions, provide more diverse input methods in limited operation space, and provide users with a good operating experience. In addition, by stacking the touch layer, writing layer, display layer and tactile feedback layer in sequence from top to bottom, or by stacking the touch layer, display layer, writing layer and tactile feedback layer in sequence from top to bottom, the integrated input module can support the operation of active pen or passive pen, and the execution of each layer cannot affect each other.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. An integrated input module, comprising:
a display layer comprising a light-emitting side and a backlight side corresponding to each other;
a touch layer disposed on the light-emitting side of the display layer, and configured to generate a touch signal based on a user's touch operation on the touch layer;
a writing layer configured to generate a writing signal based on a user's writing operation on the writing layer; and
a tactile feedback layer configured to generate corresponding vibration feedback based on the touch signal or the writing signal;
wherein the writing layer is disposed between the light-emitting side of the display layer and the touch layer, and the tactile feedback layer is disposed on the backlight side of the display layer; or the writing layer is disposed between the backlight side of the display layer and the tactile feedback layer.

2. The integrated input module according to claim 1, wherein when the writing layer is disposed between the display layer and the touch layer, the touch layer and the writing layer are integrated into one body.

3. The integrated input module according to claim 1, wherein when the writing layer is disposed on the backlight side of the display layer, the writing layer comprises an electromagnetic resonance circuit board and a magnetic conductive plate, the electromagnetic resonance circuit board is attached to the backlight side of the display layer, and the magnetic conductive plate is disposed between the electromagnetic resonance circuit board and the tactile feedback layer to uniformly distribute magnetism of the writing layer.

4. The integrated input module according to claim 1, wherein the tactile feedback layer has a first surface and a second surface corresponding to each other, the tactile feedback layer comprises a tactile feedback circuit board and at least one vibrator, the backlight side of the display layer or the writing layer is attached to the first surface of the tactile feedback layer, and the at least one vibrator is disposed on the second surface of the tactile feedback layer and is configured to generate the corresponding vibration feedback according to the touch signal or the writing signal.

5. The integrated input module according to claim 4, wherein the at least one vibrator comprises at least one of a piezoelectric ceramic actuator and a linear resonant actuator.

6. The integrated input module according to claim 4, wherein when the writing layer is disposed between the display layer and the touch layer, and the writing layer and the touch layer are integrated into an integrated input layer, the integrated input module further comprises:
a first electronic component disposed on the second surface of the tactile feedback layer and electrically connected to the display layer to control the display layer; and
a second electronic component disposed on the second surface of the tactile feedback layer and electrically connected to the integrated input layer to control the integrated input layer.

7. The integrated input module according to claim 4, wherein when the writing layer is disposed on the backlight side of the display layer, the integrated input module further comprises:
a third electronic component disposed on the second surface of the tactile feedback layer and electrically connected to the display layer to control the display layer;
a fourth electronic component disposed on the second surface of the tactile feedback layer and electrically connected to the touch layer to control the touch layer; and
a fifth electronic component disposed on the second surface of the tactile feedback layer and electrically connected to the writing layer to control the writing layer.

8. The integrated input module according to claim 1, further comprising:
a protective layer disposed on the touch layer to cover the touch layer;
a cover body having an opening;
a supporting body combined with the cover body to form an accommodation space, so that the display layer, the touch layer, the protective layer, the writing layer and the tactile feedback layer are disposed in the accommodation space, and a surface of the protective layer is exposed from the opening of the cover body; and
a buffer member disposed on the tactile feedback layer and in contact or not in contact with the supporting body, so as to absorb the corresponding vibration feedback generated by the tactile feedback layer.

9. The integrated input module according to claim 8, wherein the protective layer and the cover body are integrally formed.

10. The integrated input module according to claim 8, wherein when the writing layer is disposed between the display layer and the touch layer, and the writing layer and the touch layer are integrated into an integrated input layer, the integrated input module further comprises:
a first glue layer disposed between the protective layer and the integrated input layer, and connected to the protective layer and the integrated input layer; and
a second glue layer disposed between the integrated input layer and the display layer, and connected to the integrated input layer and the display layer.

11. The integrated input module according to claim 8, wherein when the writing layer is disposed on the backlight side of the display layer, the integrated input module further comprises:
a third glue layer disposed between the protective layer and the touch layer, and connected to the protective layer and the touch layer; and
a fourth glue layer disposed between the touch layer and the display layer, and connected to the touch layer and the display layer.
